(19) United States
(12) Patent Application Publication
(10) Pub. No.: US 2022/0067605 A1
(43) Pub. Date: Mar. 3, 2022

(54) RIDE ACCESS POINT DEFECT SCORING USING SPATIAL INDEX

(71) Applicant: Uber Technologies, Inc., San Francisco, CA (US)

(72) Inventors: Yuxing Zhang, San Francisco, CA (US); Adnan Akil, San Francisco, CA (US); Sina Kashuk, San Francisco, CA (US); Gabriel Durkin, San Francisco, CA (US); Shivendra Pratap Singh, Redwood City, CA (US); Zheng Li, San Francisco, CA (US)

(21) Appl. No.: 17/408,032

(22) Filed: Aug. 20, 2021

Related U.S. Application Data
(60) Provisional application No. 63/072,192, filed on Aug. 30, 2020.

(51) Int. Cl. G06Q 10/06

(52) U.S. Cl. CPC G06Q 10/06311

(57) ABSTRACT

A transportation management system determines trip defects associated with trip access points based on historical trip data. The transportation management system aggregates historical trip data in a spatial index. The transportation management system represents the spatial index using a geographic grid including grid cells at various resolutions. The transportation management system determines a defect score for individual grid cells at a given resolution based on the trip data in the spatial index corresponding to the grid cell. The transportation management system uses the defect scores for grid cells to provide a dynamic user experience to users of the transportation management system (e.g., riders or drivers) on their respective client devices.

### CROSS REFERENCE TO RELATED APPLICATIONS

This application claims the benefit of U.S. Provisional Application No. 63/072,192, filed Aug. 30, 2020, which is incorporated by reference in its entirety.

### BACKGROUND

The described embodiments generally relate to transportation management systems, and more particularly to providing a dynamic user experience based on identified trip defects.

Transportation management systems provide support for logistical issues in managing the transportation of people, cargo, or the like. In some systems, a driver provides transportation services to a user requesting a trip (e.g., a rider) from a pick-up location to a drop-off location selected by the requesting user. Typically, the pick-up and drop-off locations for a trip are input by the requesting user. Some pick-up or drop off locations may be in an environment with characteristics resulting in problems or inefficiencies in executing a trip. For example, the pick-up or drop-off locations may be in a densely populated area, located on a multi-level road segment such as an under-pass, have restricted access, be obscured by objects such as buildings or hedges, etc. Existing transport management systems do not identify and dynamically respond to environmental characteristics around pick-up or drop-off locations, which negatively impacts the execution of a trip.

### SUMMARY

A method, system, and computer-readable storage medium are disclosed for determining trip defects associated with trip access points based on historical trip data. A transportation management system aggregates historical trip data (e.g., trip cancellations, trip requests, pick-up distance errors, etc.) and stores the aggregated trip data in a spatial index. The transportation management system represents the spatial index using a geographic grid including grid cells at various resolutions. Using the geographic grid, the transportation management system determines a defect score for individual grid cells at a given resolution based on the trip data in the spatial index corresponding to the grid cell. The defect score for a grid cell indicates a likelihood of defects occurring for trips using trip access points within the grid cell. The transportation management system uses the defect scores for grid cells to provide a dynamic user experience to users of the transportation management system (e.g., riders or drivers) on their respective client devices.

In some embodiments, the transportation management system receives information associated with requesting a trip from a client device located at a geographic position. After receiving the information, the transportation management system identifies, based on the geographic position, a grid cell of a plurality of grids cells included in a geographic grid representing a spatial index of historical trip data. The transportation management system determines a defect score for the grid cell indicating a likelihood of defects occurring for trips using trip access points within the grid cell. In particular, the transportation management system determines the defect score based on one or more trip metrics corresponding to the historical trip data associated with the grid cell. Based on the defect score, the transportation management system selects a trip access point from a set of candidate trip access points for the trip. The transportation management system provides information describing the trip which includes the selected access point to the client device.

In some embodiments, the transportation management system calculates a defect score for a grid cell based on a nonlinear combination of one or more trip metrics determined using historical trip data (e.g., trip cancellation rate, trip contact rate, access point distance error, etc.). In the same or different embodiments, the defect score is determined using a machine learning pipeline trained using one or more trip metrics of the spatial index or other historical trip data.

### BRIEF DESCRIPTION OF THE DRAWINGS

FIG. 1 illustrates the system environment for a transportation management system, in accordance with an embodiment.

FIG. 2 illustrates an embodiment of a transportation management module, in accordance with an embodiment.

FIG. 3A illustrates a visualization of a geographic grid representing a spatial index, in accordance with an embodiment.

FIG. 3B illustrates an access point region including a set of access points in proximity to a rider device location, in accordance with an embodiment.

FIG. 4A illustrates a user interface including a recommended pick-up access point, in accordance with an embodiment.

FIG. 4B illustrates a user interface displaying a set of candidate access points for a trip with visual indications of the relative defect scores of the set of candidate access points, in accordance with an embodiment.

FIG. 4C illustrates a user interface for soliciting feedback from a rider through a rider device 120 regarding environmental characteristics near one or more access points, in accordance with an embodiment.

FIG. 4D illustrates a user interface including a warning regarding a selected pick-up access point, in accordance with an embodiment.

FIG. 5 is a flowchart illustrating a method for selecting a trip access point, in accordance with an embodiment.

FIG. 6 illustrates example components of a computer used as part or all of the network system, the rider client device, or the driver client device, in accordance with an embodiment.

### DETAILED DESCRIPTION

The Figures and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

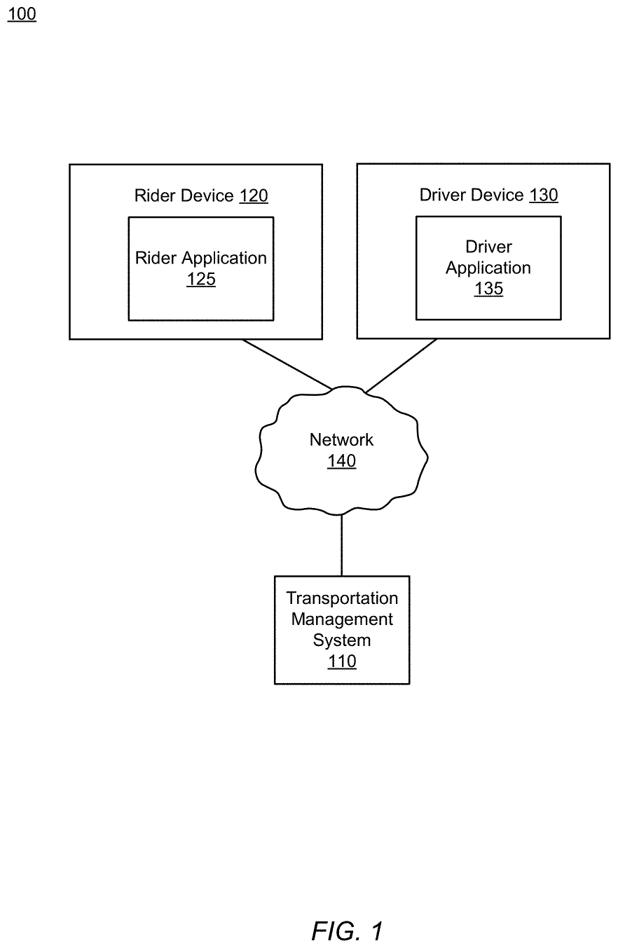

Turning now to the specifics of the system architecture, FIG. 1 illustrates a system environment 100 for a transportation management system 110. In the embodiment shown, the system environment 100 includes a transportation management system 110, a rider device 120, a driver device 130, and a network 140. In other embodiments, the system environment 100 includes different or additional elements. Furthermore, the functionality may be distributed among the elements in a different manner than described.

The transportation management system 110 coordinates the transportation of persons or goods/items for a rider by a service provider (e.g., a driver of a vehicle). The term “rider” is used herein to refer to a user who requests transportation services from the transportation management system 110 to transport themselves, other individuals, or goods/items. As such, a rider is not necessarily transported as part of a trip requested by the rider. The driver uses a vehicle to provide the transportation services to the rider from a pick-up access point (e.g., a pick-up location) to a drop-off access point (e.g., a drop-off location). The transportation management module 110 communicates with the rider device 120 and the driver device 130 in order to facilitates a trip from the pick-up access point to the drop-off access point.

Furthermore, the transportation management module 110 identifies geographic regions including trip access points experiencing trip defects for trips including the trip access points. As used herein, a trip defect refers to one or more trip metric values determined for one or more trips significantly differing from corresponding values which are considered indicative of successful trip execution (e.g., above or below a threshold value). Example trip defects include an access point distance error (e.g., the distance between the location where a rider requested a trip and the actual pick-up location), a cancellation of the trip by the rider or driver, an occurrence of a trip request, etc. The trip metric values can be determined based on data describing one or more trips using various statistical methods (e.g., counts, averages, modes, frequencies, etc.). For example, trip metrics may include an average access point distance error, an average cancellation rate, an average trip request rate for a geographic area, etc.

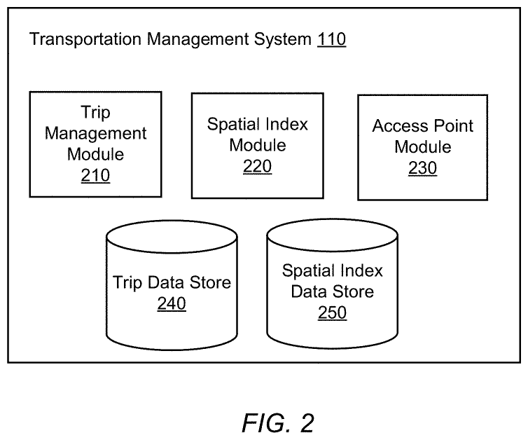

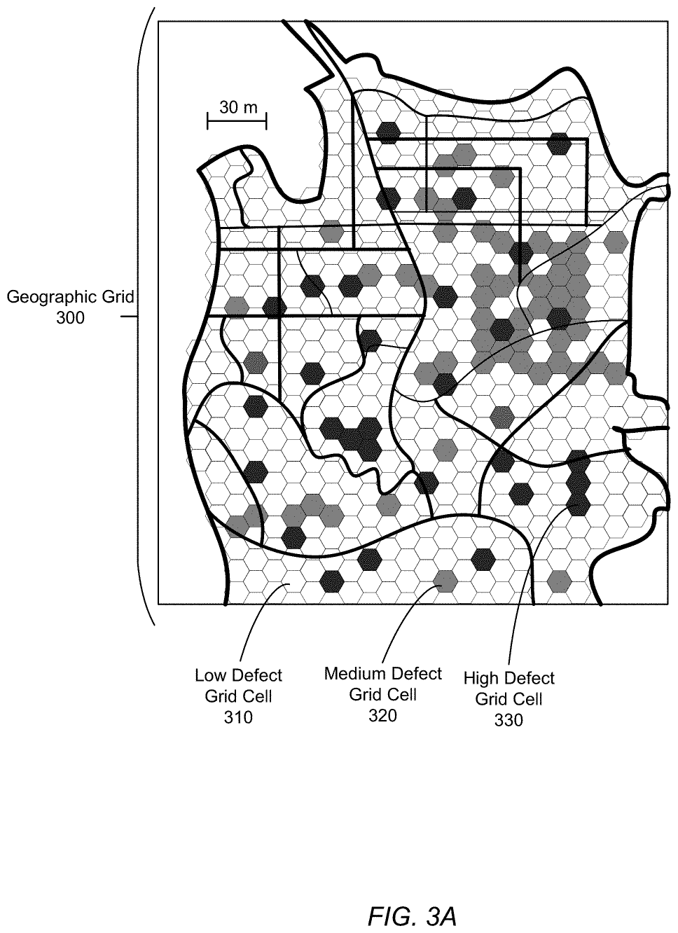

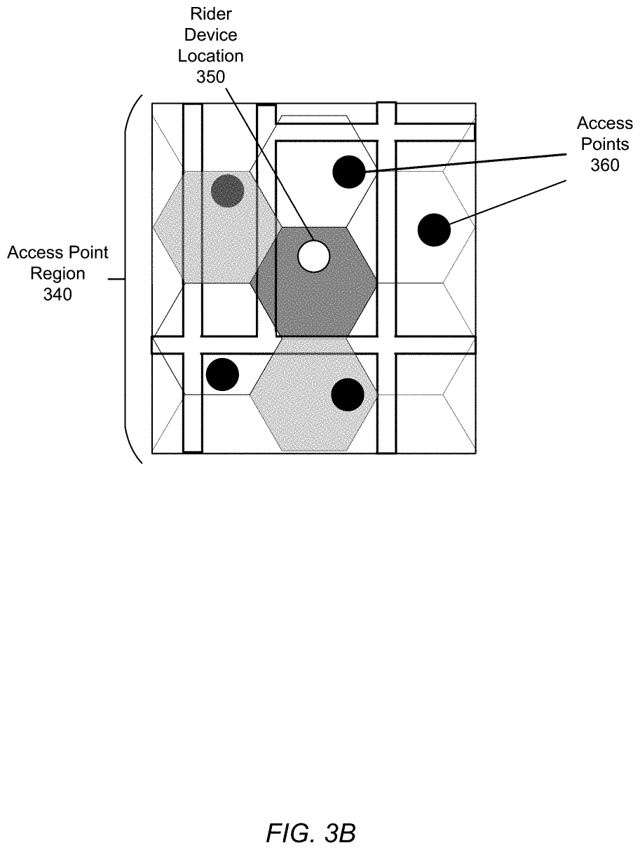

In described embodiments, the transportation management system 110 identifies trip access points experiencing trip defects based on historical trip data aggregated in a spatial index organizing the trip data according to geographic locations associated with the trip data (e.g., as determined by GPS components of the rider device 120 or driver device 130). In order to identify trip access points experiencing trip defects the transportation management module 110 may determine defect scores for individual grid cells of a geographic grid using historical trip data corresponding to a geographic region designated by the grid cell. A defect score indicates a likelihood of defects occurring for trips using trip access points within the grid cell. Trip defects may be occurring for trips in the geographic region defined by a grid cell for a variety of reasons, such as environmental characteristics of the geographic region (poor visibility, multi-level roads, heavy traffic, etc.), a lack of information describing the geographic region of the grid cell (e.g., missing roads, inaccurate roads, etc.), local regulations (e.g., traffic violations), traffic congestion, parking spot availability, other aspects of the geographic region, or some combination thereof. The determination of defect scores using the spatial index is described in greater detail below with reference to FIGS. 2 and 3A-B.

A rider operates a rider device 120 including a rider application 125 that communicates with the transportation management system 110. The term “rider” as used herein refers to a user who requests transportation services from the transportation management system 110 for themselves, other individuals, or other items, and therefore is not necessarily transported as part of a trip resulting from the request. The rider interacts with the rider application 125 using the rider device 120 to coordinate transportation services through the transportation management system 110. For instance, the rider can make a request for a trip from the transportation management system 110, such as a delivery of items, such as cargo needing transport, or transportation for the rider or additional persons. The rider application 125 enables the rider to specify access points for a trip, such as a pick-up access point or a drop-off access point for the trip. A pick-up access point or drop-off access point may be a location input by the rider or may correspond to the current location of the rider device 120, such as determined by a global positioning system (GPS) component of the rider device 120, a wireless networking system, or a combination thereof. For purposes of simplicity, as described herein, a pick-up or drop-off access point can include a pick-up or drop-off location, respectively, for a trip which is (i) determined by the rider application 125 (e.g., based on the current location of the rider device 120 using a GPS component), (ii) specified or selected by the rider, or (iii) determined by the transportation management system 110. In some embodiments, the transportation management system 110 recommends one or more access points for a trip to a rider based on historical trip data and environmental characteristics associated with the location of an access point or location of the rider device 120, as discussed below with reference to FIGS. 2, 3A-B, and 4A-D.

According to examples herein, the rider device 120 can transmit a set of data (referred to herein as “service data”) to the transportation management system 110 over the network(s) 140 in response to rider input or operation of the rider application 125. Such service data can be indicative of the rider's interest in potentially requesting a trip (e.g., before actually confirming or requesting the trip). For example, the rider may launch the rider application 125 and specify an origin location or a destination location to view information about a trip before making a decision on whether to request the trip. The rider may want to view information about the average or estimated time of arrival for pick up by a driver, the estimated time to the destination, the price, the available transportation service types, etc. Depending on implementation, the service data can include the geographic position of the rider device 120, information describing an origin or destination location desired by the rider, rider information (e.g., an account identifier), application information (e.g., version number), a rider device 120 identifier or type, etc. According to some examples, each time the rider modifies the origin or destination location, the rider application 125 can generate and transmit the service data to the transportation management system 110.

Once the rider confirms or orders a trip via the rider application 125, the rider application 125 can generate data corresponding to a request for the trip through the transportation management system 110 (i.e., a trip request). Responsive to receiving a trip request, the transportation management system 110 uses information from the trip request to match the rider with a driver among one or more available drivers. Depending on implementation, the trip request can include rider or device information (e.g., a rider identifier, a device identifier), a transportation service type (e.g., vehicle type), a pick-up location, a drop-off location, a payment profile identifier, or other data. The transportation management system 110 selects a driver from a set of drivers, such as based on the driver's current location and status (e.g., offline, online, available, etc.) or information from the trip request (e.g., transportation service type, pick-up location, or drop-off location), to provide the trip for the rider and transport the rider (or other individuals or items) from the pick-up location to the drop-off location. Responsive to selecting an available driver, the transportation management system 110 sends an invitation message to the driver device 130 inviting the driver to fulfill the trip request.

The driver operates a driver device 130 including a driver application 135 that communicates with the transportation management system 110. The driver interacts with the driver application 135 using the driver device 130 to provide information indicating whether the driver is available or unavailable to provide transportation services to riders. The driver application 135 can also present information about the transportation management system 110 to the driver, such as invitations to provide trips, navigation instructions, map data, etc. In some embodiments, the driver application 135 enables the driver to provide information regarding availability of the driver by logging into the transportation management system 110 and activating a setting indicating that they are currently available to provide trips. The driver application 135 also provides the current location of the driver or the driver device 130 to the transportation management system 110. Depending on implementation, the current location may be a location input by the driver or may correspond to the current location of the driver device 130 as determined by a GPS component of the driver device 130, a wireless networking system, or a combination thereof. The driver application 135 further allows a driver to receive, from the transportation management system 110, an invitation message to provide a trip for a requesting rider, and if the driver accepts via input, the driver application 135 can transmit an acceptance message to the transportation management system 110. The transportation management system 110 can subsequently provide information about the driver to the rider application 125 on the rider device 120. In the same or different embodiment, the driver application 135 can enable the driver to view a list of current trip requests and to select a particular trip request to fulfill. The driver application 135 can also receive routing information from the transportation management module 110. The driver application 135 enables a driver to provide a rating for a rider upon completion of a trip. In one embodiment, the rating is provided on a scale of one to five, five being the maximal (best) rating.

The rider device 120 and the driver device 130 are portable electronic computing devices such as smartphones, tablet devices, wearable computing devices (e.g., smartwatches) or similar computing devices. Alternatively, the driver device 130 can correspond to an on-board computing system of a vehicle. Computing devices typically have one or more processors, memory, touch screen displays, wireless networking system (e.g., IEEE 802.11), cellular telephony support (e.g., LTE/GSM/UMTS/CDMA/HSDPA, etc.), and location determination capabilities.

The rider device 120 and the driver device 130 interact with the transportation management system 110 through client applications (i.e., the rider application 125 and driver application 135, respectively) configured to interact with the transportation management system 110. The rider application 125 and the driver application 135 can present information received from the transportation management system 110 on a rider interface, such as a map of the geographic region, and the current location of the rider device 120 or the driver device 130. The rider application 125 and the driver application 135 can determine the current location of the relevant device and provide the current location to the transportation management system 110.

The network 140 connects the rider device 120 and the driver device 130 to the transportation management system 110. The network 140 may be any suitable communications network for data transmission. In an embodiment such as that illustrated in FIG. 1, the network 140 uses standard communications technologies or protocols and can include the internet. In another embodiment, the entities use custom or dedicated data communications technologies.

FIG. 2 illustrates an embodiment of the transportation management module 110. In the embodiment shown, the transportation management module 110 includes a trip management module 210, a spatial index module 220, an access point module 230, a trip data store 240, and a spatial index data store 250. In other embodiments, there may be different or additional components than those shown in FIG. 2. Furthermore, some or all of the operations described for the transportation management module 110 below may be performed on the rider device 120, the driver device 130, or another suitable device.

The trip management module 210 is configured as a communicative interface between the rider application 125, the driver application 135, and the various modules and data stores in the transportation management system 110, and is one means for performing this function. The trip management module 210 receives driver availability status information and current location information from the driver application 135 and updates the trip data store 240 with the availability status. The trip management module 210 also receives trip requests from the rider application 125 and creates corresponding trip records in the trip data store 240. According to an example, a trip record corresponding to a trip request can include or be associated with a trip ID, a rider ID, a pick-up access point, a drop-off access point, a transportation service type, pricing information, or a status indicating that the corresponding trip request has not been processed. According to one example, when a driver accepts the invitation message to service a trip request for a rider, the trip record can be updated with the driver's information as well as the driver's location and the time when the trip request was accepted. Similarly, location and time information about the trip as well as the cost for the trip can be associated with the trip record.

The trip management module 210 further communicates with the access point module 230 in order to identify a set of candidate access points for a trip request. For example, a rider can initiate the process of requesting a trip on the rider device 120 via the rider application 125, during which process the rider application 125 and the trip management module 210 may communicate back and forth in order to complete a trip request. For example, the trip management module 210 can receive service data from the rider device 120, as described above with reference to the rider device 120. As part of the process of requesting a trip, the trip management module 210 may provide service data to the access point module 230 (e.g., the location of the rider device 120, an intended destination location for a trip, an identifier of an account of the rider stored on the transportation management system 110, etc.). Based on the provided service data, the trip management module 210 may receive one or more candidate access points for the trip (e.g., pick-up or drop-off access points) from the access point module 230. Selection of access points by the access point module 230 is described in greater detail below. After receiving one or more candidate access points, the trip management module 210 may provide the one or more candidate access points to the rider device 120 in order for the rider to select a pick-up access point and a drop-off access point for the trip and confirm a trip request for a trip using the selected access points. In some embodiments, the trip management module 210 automatically creates trip requests for the rider, such as by automatically selecting a pick-up and drop-off access point from the one or more candidate access points based on the information provided by the rider device 120.

In one embodiment, during execution of a trip, the trip management module 210 receives information (e.g., periodically) from the driver application 135 indicating the location of the driver's vehicle or telematics information (e.g., indications of current speed, acceleration/deceleration, events, stops, and so forth). The trip management module 210 stores the information in the trip data store 240 and can associate the information with the trip record. In some embodiments, the trip management module 210 periodically calculates the driver's estimated time of arrival (DETA) at the pick-up location and provides the DETA to the rider application 125.

The spatial index module 220 generates a spatial index of historical trip data and location characteristics organized by corresponding geographic locations. The spatial index module 220 retrieves historical trip data from the trip data store 240 (e.g., data within historical trip records) and stores the trip data in the spatial index based on a geographic coordinate associated with the data (e.g., a longitude-latitude coordinate). The spatial index module 220 stores the spatial index in the spatial index data store 250. In described embodiments, the spatial index module 220 represents the spatial index using a geographic grid including grid cells designating a geographic region, as described above with reference to the transport management system 110. For example, the spatial index module 220 may associate trip data corresponding to a pick-up (e.g., rider location and time of trip request, rider location and time of pick-up, rider location and time of trip cancellation etc.) with a grid cell where the pick-up access point is located or where the rider requested the trip. The geographic grid represented by the spatial index module 220 may further include grid cells at a variety of resolutions ranging from a relatively low resolution (e.g., grid cells with a diameter of 50 meters or less) to a relatively high resolution (e.g., grid cells with a diameter over 50 meters). In particular, the spatial index module 220 can represent a geographic grid with grid cells at resolutions high enough to capture trip metrics corresponding to individual access points, such as grid cells having diameters of one to ten meters. In this way, the spatial index module 220 can identify data that is highly localized to a relatively small geographic region, such as to provide for processing to other components of the transportation management system 110 (e.g., the access point module 230).

The spatial index module 220 can further use the historical trip data to determine trip metrics for grid cells providing various indicators of whether a trip was or was not successful within the grid cell. Example trip metrics for a grid cell include a value for trip requests (e.g., a total count or frequency of trip requests), a value for pick-ups occurring within the grid cell (e.g., a total count or frequency of pick-ups), a value for drop-offs occurring within the grid cell (e.g., a total count or frequency or drop-offs), a value for particular access points being used for a trip within the grid cell (e.g., a total count or frequency of access points being used), a value for access point distance errors (e.g., an average distance), or various other indicators describing the execution of trips within a grid cell. The spatial index module 220 is further configured to provide information describing the geographic grid to other components of the transportation management system 110 to be used for various processes.

In some embodiments, the spatial index module 220 generates the trip metrics for grid calls by performing a smoothing operation over grid cells at a higher resolution to grid cells at a lower resolution. In particular, the spatial index module 220 may convolve the trip cell metrics for a set of higher resolution cells to a lower resolution cell encompassing the higher resolution cells. As such, the spatial index module 220 may account for geographic sparsity of the historical trip data. The particular convolution technique used by the spatial index module 220 may depend on the geometry of the geometric grid and grid cells. For example, if the grid cells are squares, the spatial index 220 may use various two-dimensional matrix convolutions to smooth the trip metric data. As another example, if the grid cells are hexagons, as depicted in FIGS. 3A-B, the spatial index module 220 may perform a convolution using one or more rings of grid cells around a central grid cell (i.e., a “K-ring convolution”). In one embodiment, the spatial index module 220 performs the smoothing operation by first determining trip metrics for a set of high resolution grid cells using historical trip data corresponding to the high-resolution grid cells, and then propagating the trip metrics to other nearby high resolutions grid cells (e.g., grid cells separated by less than a threshold number of grid cells). After propagating the trip metrics, the spatial index module 220 performs a smoothing operation of the trip metrics from the set of high-resolution grid cells to a lower resolution grid cell including the set of high-resolution grid cells (e.g., a convolution operation, as described above).

In some embodiments, the spatial index module 220 periodically updates the spatial index stored in the spatial index data store 250. For instance, the spatial index module 220 may query the trip data store 240 at a set time interval (e.g., weekly, monthly, yearly, etc.) for new historical trip data and use the new historical trip data to update the trip metrics for corresponding grid cells of the geographic grid. The spatial index module 220 may update the entire spatial index at once, or may update different portions (e.g., geographic regions) of the spatial index (e.g., portions storing data corresponding to different geographic regions) at different times. For example, the spatial index module 220 may update portions of the spatial index corresponding to geographic regions with relatively high trip activity (e.g., a major metropolitan area) more frequently than portions of the spatial index corresponding to geographic regions with relatively low trip activity (e.g., a small town or an area in the countryside).

In some embodiments, the spatial index module 220 determines additional trip metrics for grid cells such as a rate at which particular sets of coordinates have been used as pick-up locations and feedback from riders or drivers. Additionally, or alternatively, trip metrics might include rider ratings for drivers or driver ratings for riders. For example, in some circumstances, a low rating for a driver might suggest a problem during the pick-up process, e.g., the rider was unable to find or reach the driver's vehicle, potentially due in part to the specific pick-up location for that trip. Further, in some embodiments, historical ride data for a pick-up access point includes inferred characteristics of the pick-up access point based on aggregations of sensor traces and interactions from riders and drivers during pick-ups at pick-up locations associated with the pick-up access point, such as the frequency with which riders and drivers call each other at the pick-up location, the frequency with which the pick-up of the rider occurs at a location more than a threshold distance away from the pick-up location, or the frequency with which a driver arrives at the pick-up location before the rider's arrival.

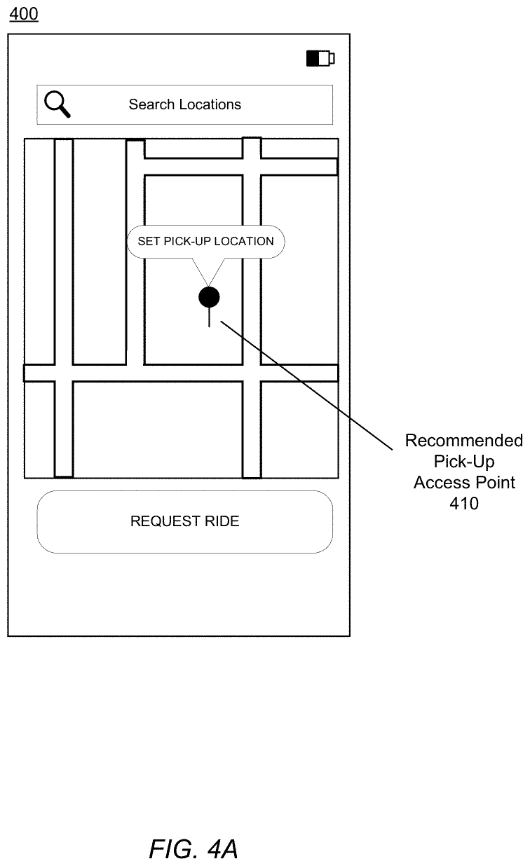

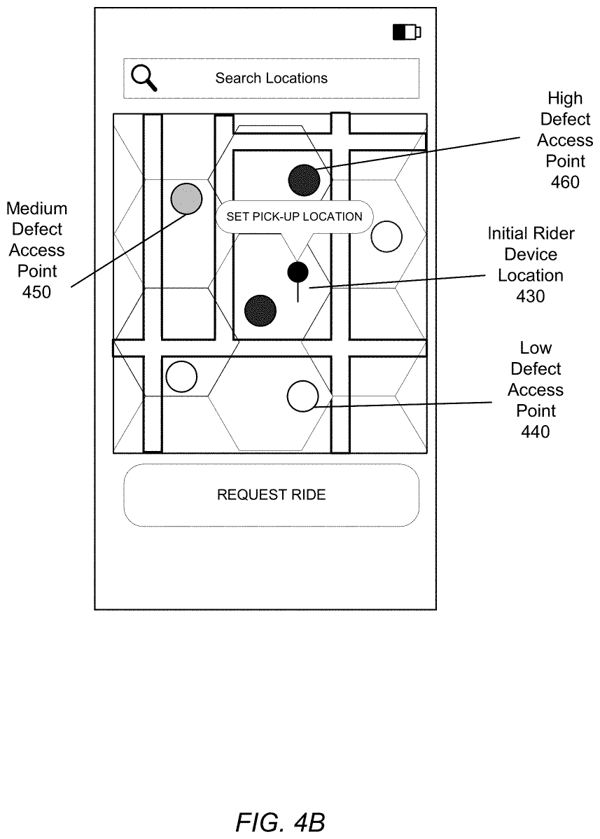

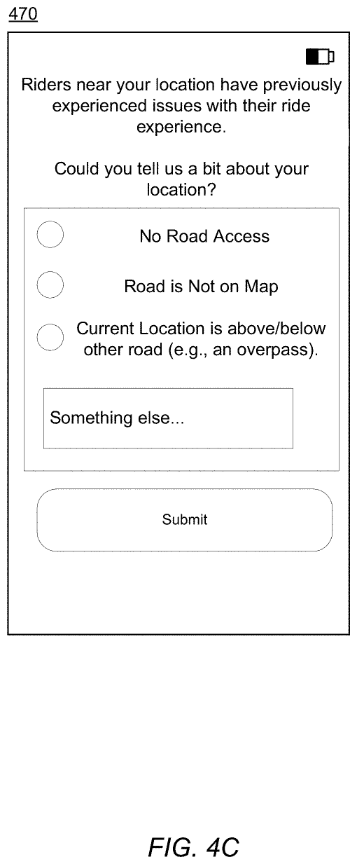

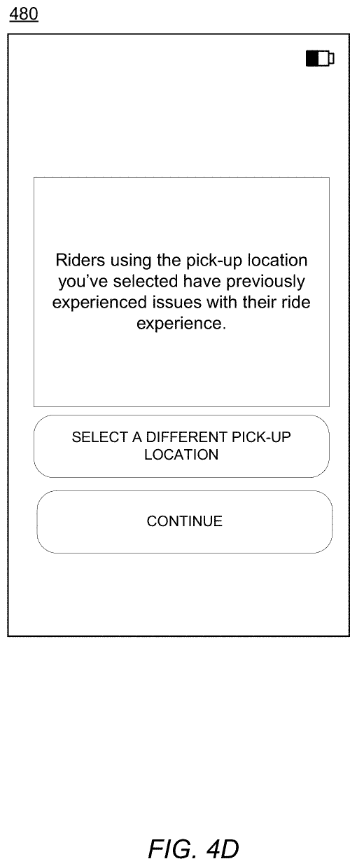

In some embodiments, the spatial index module 220 further stores environmental characteristics of locations or regions, such as the environmental characteristics of the geographic region defined by a grid cell of the geographic grid. The environmental characteristics stored by the spatial index module 220 in the spatial index can include traffic or other road and sidewalk conditions and restrictions at the origin location or at a pick-up access point. For example, road conditions and restrictions at the origin location might include one-way streets, bus lanes, bike lanes, fire lanes, bus stops, taxi stands, construction, and road or lane closures, etc. Sidewalk conditions might include fire hydrants or barriers between the sidewalk and the road (e.g., fences, hedges, etc.). In some embodiments, the environmental characteristics of locations are received by the transportation management system 110 from a rider device 120 or a driver device 130. In particular, the transportation management system 110 may prompt the rider or the driver to provide information describing environmental characteristics of their locations or of a trip access point. For example, the spatial index module 220 may solicit feedback from riders and drivers after a trip, including whether the pick-up location was a suitable pick-up location. For example, a rider might specify that the pick-up location was not suitable because it was in front of a bus stop or a taxi stand. Additionally, the transportation management system 110 may store the environmental characteristics in the trip data store 240 (e.g., in association with a relevant trip record), or may store the environmental characteristics directly in the spatial index data store 250. Soliciting feedback from the rider device 120 regrading environmental characteristics is described in greater detail below with reference to the access point module 230 and FIG. 4C.

The access point module 230 manages trip access points for trips facilitated by the transportation management system 110. In embodiments, the access point module 230 processes historical trip data in the trip data store 240 in order to generate access points, such as locations from which trips are frequently requested or locations which are often chosen as the destination for trips. The access point module 230 may store the generated access point in the trip data store 240, the spatial index data store 250, or another database (e.g., an access point store). The access point module 230 further uses the trip metrics of the spatial index stored in the spatial index data store 250 to identify access points associated with trip defects. In particular, the access point module 230 may use the trip metrics for a grid cell to determine a defect score for the grid cell, as described above with reference to the transportation management module 110. The defect score may be determined using various methods, such as using a nonlinear combination of trip metrics (e.g., a defect score equation) or a defect score model trained to predict a defect score. The access point module 230 can further use the defect score to provide dynamic user experiences on to the rider or driver through the rider application 125 or driver application 135, respectively. Specific techniques for determining defect scores for grid cells and using defect scores to provide a dynamic user experience are described below in greater detail with reference to the access point module 230 and FIGS. 3A-B and 4A-C. In response to receiving service data associated with a rider device 120 in the process of requesting a trip from the trip management module 210, the access point module 230 determines a set of candidate access points for the trip in the process of being requested. The access point module 230 selects the set of candidate access points from the generated access points and provides the candidate access points to the trip management module 210. The set of candidate access points may be determined using various methods, such as by identifying some or all of the access points within a threshold distance from the location of the rider device 120 at request time or by identifying a threshold number of closest access points to the location of the rider device 120 at request time.

In some embodiments, the access point module 230 determines defect scores for grid cells using a nonlinear combination of trip metrics corresponding to the grid cells. In an exemplary embodiment, the access point module 230 uses a trip request metric for a grid cell (v_{request}), a trip cancellation metric for a grid cell (v_{cancel}), a trip pick-up distance error metric for a grid cell (v_{PDE}), and a total number of completed trips originating from the grid cell nₜᵣᵢₚₛ to determine a defect score. In this case, the access point module 230 may use the following equations to determine the defect score:

success score=([(1−v_{cancel})²·(1−v_{PDE>50})·(1−v_{PDE>100})·(1−v_{request})]^{(1+1/n}^{ₜᵣᵢₚ}^{)/5)5} 1

defect score=1−success score 2

In this case, equation 1 provides a success score indicating a probability from 0.0 to 1.0 that a defect will not occur for trips within a grid cell. Equation 2 provides a defect score indicating the probability that a defect will occur for trips within the grid cell. The access point module 230 may process trip metrics included in the spatial index data store 250 to calculate the values used in equation 1 or used in another equation or method (e.g., normalizing raw counts or averages for the trip metrics). In some embodiments, the access point module 230 uses variations of equations 1 or 2 or other equations to determine a defect score for a grid cell, such as various other linear or nonlinear equations. In the same or different embodiments, the access point module 230 determines a defect score for an access point by combining a success score for an access point (e.g., the success score of equation 1) with the distance between the rider and the access point. For example, the access point module 230 may weight the success score based on the distance.

In some embodiments, the access point module 230 uses machine learning techniques to train a machine learning model configured to predict a defect score for grid cells (referred to herein as a “defect score model”). For instance, the access point module 230 may train the defect score model to predict a defect score indicating a likelihood of one or more trip defects occurring (e.g., a trip cancellation, an access point distance error above a threshold, etc.) based on other trip metrics or information describing the environmental characteristics of a grid cell. The access point module 230 may train the defect score model using trip data in the trip data store 240, the spatial index data store 250, or both. The access point module 230 may use various machine learning or other statistical techniques to train the defect score. These techniques can include supervised neural networks (e.g., convolutional neural networks), support vector machines, linear regression, logistic regression, decision trees, and any other supervised learning technique usable to train a model to predict a likelihood of defects occurring for a trip in a geographic region. These techniques can also include unsupervised neural networks (e.g., autoencoders, adversarial networks, etc.), k-means clustering, principal component analysis, and any other unsupervised learning technique usable to train a model to predict a likelihood of defects occurring for a trip in a geographic region. In various embodiments, the access point module 230 trains and uses a machine learning pipeline including several models (e.g., several defect score models) using one of the supervised or self-supervised techniques described above. In the same or different embodiments, the access point module 230 may use machine learning techniques to train a machine learning pipeline including one or more models configured to predict defect scores for individual access points (e.g., access point defect scores, as described below).

In some embodiments, the access point module 230 pre-computes defect scores for grid cells (e.g., on a periodic basic using trip metrics corresponding to a particular time interval, such as a week or month). In this case, the access point module 230 can retrieve the previously computed defect scores for grid cells corresponding to service information associated with a trip in the process of being requested. In the same or different embodiments, the access point module 230 computes defect scores for grid cells in response to receiving service data for a trip in the process of being requested.

In various embodiments, the access point module 230 uses the defect scores of one or more grid cells to select one or more candidate access points from a set of candidate access points. In one embodiment, the access point module 230 removes access points from a group of candidate access points for a trip (e.g., a threshold number of closest access points to the location of the rider device 120) if the access points are within a grid cell with a defect score below a threshold. In the same or different embodiment, the access point module 230 ranks access points (e.g., a group of candidate access points for a trip) from multiple grid cells using the defect scores for the grid cells, such as by ranking access points from grid cells with lower defect scores more highly. Further in the same or different embodiment, the access point module 230 identifies access points in grid cells with high defect scores (e.g., above a defect score threshold) and solicits feedback from rider devices 120 or driver devices 130 regarding environmental characteristics of the environment around the identified access points. Environmental characteristics received from rider device 120 or the driver device 130 may be stored by the transportation management system 110 in the trip data store 240 or the spatial index data store 250. Furthermore, the trip management module 210 may use environmental characteristics to update various data, such as static map data stored in the spatial index data store 250, as described below. The trip management module 210 may additionally, or alternatively, use the environmental characteristics to determine defect scores for grid cells or access point defect scores for access points. Specific modifications of the user experience on the rider device 120 or driver device 130 using grid cell defect scores are described in greater detail below with reference to FIGS. 4A-C.

In some embodiments where the access point module 230 ranks a set of candidate access points, the access point module 230 ranks the candidate access points based on access point defect scores determined for the candidate access points. For example, the access point module 230 may select a top ranked candidate access point as the pick-up location for the trip or as a recommended pick-up location for the trip. In one embodiment, the access point module 230 provides a single selected pick-up or drop-off access point to the trip management module 210. The trip management module 210 can then send the selected pick-up or drop-off access point to the rider device 120 or the driver client device 130. The trip management module 210 may provide the selected pick-up or drop-off access point to the rider device 120 as a recommendation (e.g., as depicted in FIG. 4A), or may automatically initiate a trip using the selected pick-up or drop-off access point. In another embodiment, the access point module 230 provides multiple candidate pick-up or drop-off access points to the trip management module 210. The trip management module 210 may send the multiple pick-up or drop-off access points to the rider device 120 for the rider to select a pick-up access point from among the presented candidates (e.g., as depicted in FIG. 4B). In the same or different embodiments, information describing a pick-up or drop-off access point selected by the rider via the rider application 125 is sent from the rider device 120 to the transportation management system 110. The transportation management system 110 can then send the selected pick-up location to the driver through the driver device 130 in order to execute the trip.

In some embodiments, the access point module 230 determines scores for individual access points indicating a likelihood of defects occurring for trips including the respective access points (referred to herein as “access point defect scores”). In particular, the access point module 230 may determine access point defect scores for access points in order to select access points to provide a dynamic user experience, as described above. For instance, the access point module 230 can use defect scores for one or more grid cells at one or more resolutions to determine an access point defect score for an access point. As an example, the access point defect score may be a weighted average of defect scores for grid cells at a resolution within a threshold distance of the defect score, such as weighted by the distance of the access point from the center of each grid cell. Furthermore, the access point module 230 may determine access point defect scores using other historical data than grid cell defect scores, such as various data stored in the trip data store 240 or the spatial index module 220. For example, the access point module 230 may determine access point defect scores based on information previously provided by riders or drivers through the rider application 125 or driver application 135, respectively, describing the quality of a trip or a rating of the rider or driver. In the same or different embodiments, the access point module 230 uses data received from a rider device 120 during the process of requesting a trip to determine access point defect scores for candidate access points for the trip request. For example, if the rider's destination location is south of the current location of the rider device 120, a candidate pick-up access point on the northbound side of the street might receive a lower access point score than a candidate pick-up access point on the southbound side of the street. Overall, using one or more of the methods described above, the access point module 230 may determine distinct access point defect scores for access points within the same geographic region defined by a grid cell at a given resolution.

In some embodiments, the access point module 230 pre-computes access point defect scores (e.g., on a periodic basic using data corresponding to a particular time interval, such as a week or month). In this case, the access point module 230 can retrieve the previously computed access point defect scores for a set of candidate access points. In the same or different embodiments, the access point module 230 computes access point defect scores for candidate access points in response to receiving service data for a trip in the process of being requested.

In some embodiments, the access point module 230 allows the rider or driver to specify access point preferences for trips via the rider application 125 or driver application 135, respectively. For example, the rider might wish to be picked up close to their current location and might set the threshold at a short distance (e.g., 40 meters). Alternatively, the rider might wish to be picked up farther away from her current location (e.g., to avoid being picked up on a busy street) and might set the threshold at a longer distance (e.g., four hundred meters). Similarly, the driver might wish to pick up riders no more than a threshold distance from the location of the rider device 120 at the time the trip is requested. As such, the access point module 230 may use the access point preferences provided by the rider or driver to determine access point defect scores for a set of candidate access points.

The trip data store 240 maintains data describing riders associated with rider devices 120 (e.g., a rider account), drivers associated with driver devices 130 (e.g., a driver account), records of each in-progress and completed (i.e., historical) trip coordinated by the transportation management system 110, and any other data relevant to trips of facilitated by the transport management system 110. In some embodiments, the trip data store 240 may include multiple data stores for storing one or more specific types of data. Regarding in-progress and completed trips, each trip provided by a driver to a rider is characterized by a set of attributes (or variables), which together form a trip record that is stored in the trip data store 240. The attributes describe aspects of the driver, the rider, and the trip. In one embodiment, each trip record includes a trip identifier (ID), a rider ID, a driver ID, the origin location, the pick-up location, the pick-up spot, the destination location, the duration of the trip, the service type for the trip, estimated time of pick up, actual time of pick-up, and driver rating by rider, rider rating by driver, price information, market information, or other environmental variables as described below. In some embodiments, the trip record also includes rider or driver feedback regarding the pick-up spot. The variables for the trip record can therefore be drawn from multiple sources, including a rider or drivers usage history of the rider or driver application 135, respectively, or specific variables captured and received during each trip.

Regarding data describing drivers, the trip data store 240 stores account and operational information for each driver who participates in the transportation management system 110. For each driver, the trip data store 240 stores one or more database records associated with the driver, including both master data and usage data. In some examples, master data for a driver includes the driver's name, driver's license information, insurance information, vehicle information (year, make, model, vehicle ID, license plate), address information, cell phone number, payment information (e.g., credit card number), sign-up date, driver service type (regular, luxury, van, etc.), device type (e.g., type of cell phone), platform type (e.g., iOS, Android), application ID, or application version for the driver application 135).

The trip data store 240 can further store driver availability status information received from the trip management module 210, including whether the driver is available for matching or the location of the driver (which gets updated periodically). When the trip management module 210 receives a transportation request, the trip management module 210 determines, from the trip data store 240, which drivers are potential candidates to pick up the rider for the newly created trip. When the transportation management system 110 marks a trip record as complete, the transportation management system 110 can add the driver back into an inventory of available drivers in the trip data store 240.

The spatial index data store 250 stores trip data associated with one or more geographic positions (e.g., historical trip data, trip metrics, environmental characteristics, etc.) in a spatial index. In embodiments, the trip data stored in the spatial index data store 250 includes static data and dynamic data. The static data includes infrequently changing map data describing geographic regions such as street segments, location identifiers, and geographic imagery. The dynamic data includes frequently changing or updated data, such as trip data, trip metrics, grid cell defect scores, or access point defect scores.

### Exemplary Visualizations of Spatial Index and Defect Scores

FIGS. 3A-B illustrate embodiments of visualizing defect scores for geographic regions organized by a spatial index. In particular, FIG. 3A illustrates an embodiment of a visualization of a geographic grid 300 representing the spatial index. In the embodiment shown, the geographic grid 300 represents a peninsular geographic region. For example, the visualization of the geographic grid 300 may be displayed on a computing device of the transportation management system 110, such as by an administrator of the transportation management system 110. The geographic grid 300 includes hexagonal grid cells at a particular resolution with a diameter of approximately ten meters (as indicated by the 30-meter distance marker in the upper right corner of the geographic grid 300). Note that the 30-meter distance marker is included in FIG. 3A for the purposes of illustration only, and may not be included in other visualizations of the geographic grid 300. In the same or different embodiment, the geographic grid 300 can include multiple sets of grid cells each as a distinct resolution ranging from a high resolution to a low resolution. Furthermore, in alternative embodiments the geographic grid 300 represents the same geographic region using grid cells of other shapes (e.g., square, rectangular, triangular, etc.).

As depicted, the color of the grid cells of the geographic grid 300 provides an indication of the defect score for the grid cells. In particular, the geographic grid 300 includes three defect score buckets: low defect grid cells 310 (e.g., grid cells with defect scores between 0.0 and 0.33), medium defect grid cells 320 (e.g., grid cells with defect scores between 0.34 and 0.66), and high defect grid cells (e.g., grid cells with defect scores between 0.67 and 1.0). The colors of the low 310, medium 320, and high 330 defect grid cells range from white to dark grey. The three defect score buckets of FIG. 3A are depicted for the purposes of illustration only, and in other embodiments a visualization of the geographic grid 300 is depicted with additional or fewer colors indicating additional or fewer respective defect score buckets (e.g., a smooth color gradient from grid cells with defect scores of 0.0 to grid cells with defect scores of 1.0).

FIG. 3B illustrates an embodiment of an access point region 340 including a set of access points 360 in proximity to a rider device location 350. In the embodiment shown, a rider device location 350 (e.g., a rider device 120 requesting a trip) is within the access point region 340 and more specifically within a high defect grid cell 330 bordered by various other low defect grid cells 310 and medium defect grid cells 320. The access point region 340 is a geographic region including the set of candidate access points 360 for a trip being requested by the rider device. The access point region 340 may be a region within the geographic grid 300 depicted in FIG. 3A. For example, the access point region 340 may be a region within a threshold distance of the rider device location 350 or including a threshold number of closest access points 360 to the rider device location 350. The access point module 230 can select one or more of the access points 360 to provide a dynamic user experience to the rider associated with the rider device 120 at the rider device location 350, such as ranking the access points using the defect scores of their respective grid cells and providing a recommended access point for a trip requested by the rider. Although FIG. 3B depicts the rider device location 350 in relation to possible pick-up access points 360 for a pick-up location of a trip, one skilled in the art will recognize that parallel concepts apply to an intended destination location for a requested trip and corresponding drop-off access points for a drop-off location of the trip.

### Exemplary User Interfaces

FIGS. 4A-D illustrate embodiments of user interfaces provided by the transportation management module 110 for display by the rider device 120. In particular, the user interfaces depicted in FIGS. 4A-D are provided for display on the rider device 120 to provide various user experiences to a rider. In the same or different embodiments, similar interfaces may be provided for display on the driver device 130 to provide various user experiences to a driver. For example, the transport management system 110 may provide interfaces for display to the driver device 130 including messages to the driver indicating whether a pick-up or drop-off access point is in a geographic grid cell with a high defect score (e.g., an interface similar to interface 480 depicted in FIG. 4D, as described below).

FIG. 4A illustrates an embodiment of a user interface 400 including a recommended pick-up access point 410. The interface 400 may be displayed by the rider application 125 on the rider device 120 as part of the process for requesting a trip from the transport management system 110. In the embodiment shown in FIG. 4A, the recommended pick-up access point 410 is an access point corresponding to the position where a pick-up location pin labeled “SET PICK-UP LOCATION” is automatically displayed on the interface 400 (e.g., a default/initial pick-up location pin position). The recommended pick-up access point 410 may have been selected by the access point module 230 based on defect scores determined for one or more grid cells (e.g., grid cells of the geographic grid 300) defining geographic regions at or near the location of the rider device 120. For example, the recommended pick-up access point 410 may be the most highly ranked access point of a set of candidate pick-up access points based on the access point defect score for the candidate pick-up access points. The interface 400 is configured to allow the rider to move the pick-up location pin to other access points or arbitrary geographic positions to select a pick-up location for a requested trip. In some embodiments, the rider application 125 positions the pick-up location pin at other access points on the display 400 in response to interactions from the rider (e.g., other possible pick-up access points), such as snapping the pick-up location pin to other access points. Further, the snapping of the pick-up location pin may be based on a ranking of the set of candidate access points (e.g., snap to higher ranking access points within portion of the display 400.

FIG. 4B illustrates an embodiment of a user interface 420 displaying a set of candidate access points for a trip with visual indications of the relative defect scores of the set of candidate access points. The interface 400 may be displayed by the rider application 125 on the rider device 120 as part of the process for requesting a trip from the transport management system 110. In the embodiment shown in FIG. 4B, the interface 420 includes a pick-up location pin displayed at an initial position corresponding to an initial rider device location 430. In an alternative embodiment, the pick-up location pin is displayed on the interface 420 at a particular access point, similarly to the above description of the interface 400. The interface 420 also includes a set of candidate access points near the initial rider device location 430, including a low defect access point 440, a medium defect access point 450, and a high defect access point 460. Similarly to the defect score buckets described in relation to FIG. 3A, the interface 420 includes three access point buckets (i.e., low, medium, and high defect access points) and depicts the low 440, medium 450, and high 460 access points with colors ranging from white to dark grey. The access point buckets indicate a relative likelihood of defects occurring for trips using the respective access point as a pick-up location, which may be determined based on defect scores of one or more of the grid cells in FIG. 4B or access point scores, as described above with reference to the access point module 230. The three access point buckets of the interface 420 are depicted for the purposes of illustration only, and in other embodiments the access points of the interface 420 are depicted with additional or fewer colors indicating additional or fewer respective access point buckets (e.g., a smooth color gradient from access points corresponding to access point scores of 0.0 to access point scores corresponding to defect scores of 1.0).

As depicted, the display 420 includes dashed lines indicating hexagonal grid cells near the initial rider device location 430. In various alternative embodiments, the grid cells may be visible on the interface 420, or may not be visible and are instead only represented internally by the rider application 125 or the transportation management system 110.

FIG. 4C illustrates an embodiment of a user interface 470 for soliciting feedback from a rider through a rider device 120 regarding environmental characteristics near one or more access points. In the embodiment shown, the user interface 470 includes a form for providing information describing the environmental characteristics of the current location of a rider device 120 requesting a trip from the transportation management system 110. The transport management system 110 may provide the interface 470 for display, or otherwise induce the rider application 125 to display the interface 470, in order to obtain first-hand information from a rider describing environmental characteristics near one or more access points that may be causing trip defects to occur. For example, rider application 125 may display the interface 470 if the rider device 120 is within a geographic region corresponding to a grid cell with a defect score (e.g., determined by the access point module 230) is above a threshold defect score. As another example, rider application 125 may display the interface 470 if the rider device 120 is within a threshold distance from an access point with an access point score above a threshold access point score. As still another example, the rider application 125 may display the interface 470 if the rider selects an access point for a requested trip (e.g., as a pick-up or drop-off location) with an access point score above a threshold access point score.

As depicted in FIG. 4C, the interface 470 includes a form with multiple yes or no binary questions (i.e., “no road access,” “road is not on map,” etc.) and a free-form response section. In other embodiments, the interface 470 includes various other prompts for information describing environmental characteristics of the environment at or near one or more access points.

FIG. 4D illustrates an embodiment of a user interface 480 including a warning regarding a selected pick-up access point. In the embodiment shown, the user interface 480 includes a notification for a rider device 120 with a message indicating that a selected pick-up access point has previously resulted in issues for other riders. The interface 480 further provides buttons configured to allow the rider to select a different pick-up access point or to continue with the selected access point in requesting a trip from the transportation management system 110. In other embodiments, the interface 480 can include other information or can be configured to include other options for the rider. In further embodiments, a similar interface as the interface 480 is presented to a driver on the driver device 130, such as an interface including a notification warning the driver that a selected pick-up or drop-off access point for a requested trip has previously resulted in issues for the driver.

### Method for Selecting Trip Access Points Using Defect Scores

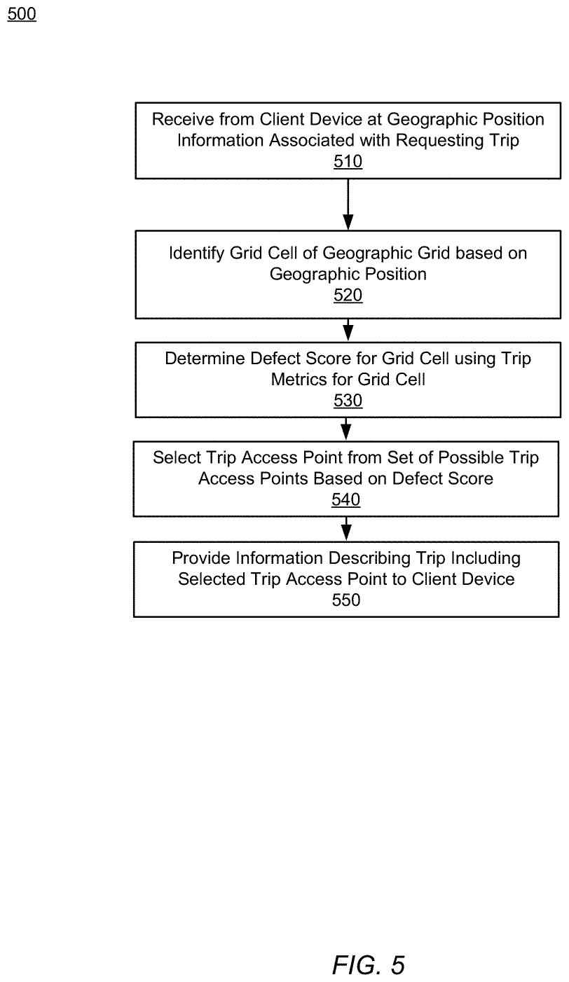

FIG. 5 is a flowchart illustrating an embodiment of a method 500 for selecting a trip access points. In the embodiment shown, the steps of FIG. 5 are illustrated from the perspective of the transportation management system 110 performing the method 500. However, some or all of the steps may be performed by other entities or components. In addition, some embodiments may perform the steps in parallel, perform the steps in different orders, or perform different steps.

In the embodiment shown in FIG. 5, the method 500 begins with the transportation management system 110 receiving 510 from a client device located at a geographic position information associated with requesting a trip. For example, the trip management module 210 may receive service data from a rider device 120 for which a rider is in the process of requesting a trip via the rider application 125. Based on the geographic position of the client device, the transportation management system 110 identifies 520 a grid cell of a geographic grid representing a spatial index of historical trip data (e.g., the spatial index data store 250). For example, the access point module 230 may identify a grid cell of a geographic grid representing the spatial index at a particular resolution which defines a geographic region within a threshold distance of the geographic position of the client device. The transportation management system 110 determines 530 a defect score for the grid cell using one or more trip metrics in the spatial index corresponding to the grid cell. For example, the access point module 230 may determine a defect score using a nonlinear combination of trip metrics corresponding to the grid cell. The transportation management system 110 selects 540 a trip access point from a set of candidate trip access points for the trip. For example, the access point module 230 may determine access point defect scores for the set of candidate trip access points and select the trip access point based on the access point defect scores. The transportation management system 110 provides 550 information describing the trip which includes the selected trip access point to the client device. For example, the trip management module 210 may provide the selected trip access point to the rider device 120 as a recommended access point for the trip, or may initiate a trip including the selected access point. As another example, the trip management module 210 may provide a notification to the rider device 120 indicating the selected access point is associated with a high defect score (e.g., an access point defect score for the access point), or may solicit feedback from the rider regarding the environmental characteristics of the environment at or near around the access point (e.g., within a threshold distance).

### Exemplary Computer Architecture

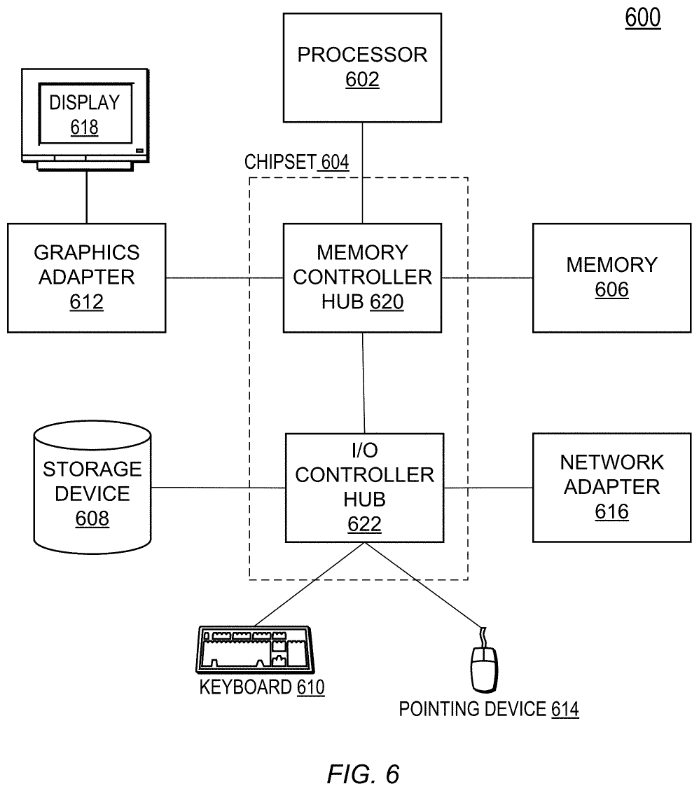

FIG. 6 is a block diagram illustrating physical components of a computer 600 used as part or all of the transportation management system 110, rider device 120, or driver device 130 from FIG. 1, in accordance with an embodiment. Illustrated are at least one processor 602 coupled to a chipset 604. Also coupled to the chipset 604 are a memory 606, a storage device 608, a graphics adapter 612, and a network adapter 616. A display 618 is coupled to the graphics adapter 612. In one embodiment, the functionality of the chipset 604 is provided by a memory controller hub 620 and an I/O controller hub 622. In another embodiment, the memory 606 is coupled directly to the processor 602 instead of the chipset 604.

The storage device 608 is any non-transitory computer-readable storage medium, such as a hard drive, compact disk read-only memory (CD-ROM), DVD, or a solid-state memory device. The memory 606 holds instructions and data used by the processor 602. The graphics adapter 612 displays images and other information on the display 618. The network adapter 616 couples the computer 600 to a local or wide area network.

As is known in the art, a computer 600 can have different or other components than those shown in FIG. 6. In addition, the computer 600 can lack certain illustrated components. In one embodiment, a computer 600, such as a host or smartphone, may lack a graphics adapter 612, or display 618, as well as a keyboard 610 or external pointing device 614. Moreover, the storage device 608 can be local or remote from the computer 600 (such as embodied within a storage area network (SAN)).

As is known in the art, the computer 600 is adapted to execute computer program modules for providing functionality described herein. As used herein, the term “module” refers to computer program logic utilized to provide the specified functionality. Thus, a module can be implemented in hardware, firmware, or software. In one embodiment, program modules are stored on the storage device 608, loaded into the memory 606, and executed by the processor 602.

### Additional Considerations

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations while described functionally computationally or logically are understood to be implemented by computer programs or equivalent electrical circuits microcode or the like. Furthermore, it has also proven convenient at times to refer to these arrangements of operations as modules without loss of generality. The described operations and their associated modules may be embodied in software firmware hardware or any combinations thereof.

Any of the steps operations or processes described herein may be performed or implemented with one or more hardware or software modules alone or in combination with other devices. In one embodiment a software module is implemented with a computer program product comprising a computer-readable medium containing computer program code which can be executed by a computer processor for performing any or all of the steps operations or processes described.

Embodiments may also relate to an apparatus for performing the operations herein. This apparatus may be specially constructed for the required purposes or it may comprise a general-purpose computing device selectively activated or reconfigured by a computer program stored in the computer. Such a computer program may be stored in a non-transitory tangible computer readable storage medium or any type of media suitable for storing electronic instructions which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process where the information is stored on a non-transitory tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the invention be limited not by this detailed description but rather by any claims that issue on an application based hereon. Accordingly, the disclosure of the embodiments of the invention is intended to be illustrative but not limiting of the scope of the invention which is set forth in the following claims.

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs that may be used to employ the described techniques and approaches. Thus, while particular embodiments and applications have been illustrated and described, it is to be understood that the described subject matter is not limited to the precise construction and components disclosed. The scope of protection should be limited only by the following claims.

1. A computer-implemented method for selecting trip access points, the method comprising:
receiving, by a transportation management system from a client device, information associated with requesting a trip, the client device located at a geographic position;
identifying, based on the geographic position, a grid cell of a plurality of grids cells included in a geographic grid representing a spatial index of historical trip data;
determining a defect score for the grid cell indicating a likelihood of defects occurring for trips using trip access points within the grid cell, the defect score determined based on one or more trip metrics corresponding to the historical trip data associated with the grid cell;
selecting, based on the defect score, a trip access point from a set of candidate trip access points for the trip; and
providing information describing the trip to the client device, the provided information including the selected trip access point.

2. The method of claim 1, further comprising:
responsive to the defect score being below a defect score threshold, requesting, from the client device, user input describing one or more environmental characteristics of the geographic position;
receiving, from the client device, information describing one or more environmental characteristics of the geographic position; and
updating the spatial index of historical ride data based on the received information describing the one or more environmental characteristics.

3. The method of claim 1, wherein the one or more trip metrics include at least one of a trip cancellation rate corresponding to the grid cell, a trip request rate corresponding to the grid cell, a trip access point distance error corresponding to the grid cell, or a completed trip count for the grid cell.

4. The method of claim 1, wherein the defect score is determined from a nonlinear combination of the trip metrics.

5. The method of claim 1, wherein determining the defect score comprises:
training a defect score model to determine defect scores for grid cells using the spatial index of historical trip data; and
determining the defect score by inputting the one or more trip metrics of the grid cell to the defect score model.

6. The method of claim 1, further comprising:
generating the geographic grid providing the spatial index of the trip data, the generating comprising:
receiving trip data associated with a plurality of trips facilitated by the transportation management system during a time period; and
associating the received trip data with corresponding grid cells of the plurality of grid cells at a plurality of resolutions of the geographic grid.

7. The method of claim 6, further comprising:
performing a smoothing operation on trip data associated with a set of grid cells of the plurality of grid cells, the smoothing operation performed over grid cells of the set of grid cells at a low resolution of the plurality of resolutions to grid cells of the set of grid cells at a high resolution of the plurality of resolutions.

8. The method of claim 1, wherein the selecting comprises:
identifying an additional grid cell of the plurality of grids cells corresponding to the geographic position and including an additional trip access point;
determining an additional defect score for the additional grid cell indicating a defect rate for transportation occurring within the additional grid cell;
ranking the trip access point and the additional trip access point based at least in part on the defect score and the additional defect score; and
selecting the trip access point based on the ranking.

9. The method of claim 8, wherein ranking the trip access point and the additional trip access point comprises:
determining a first access point defect score for the trip access point based on at least the defect score of the grid cell;
determining a second access point defect score for the additional trip access point using at least the additional defect score for the additional cell; and
ranking the trip access point and the additional trip access point based on the first and second access point defect scores.

10. The method of claim 1, wherein determining the defect score comprises:
determining the one or more trip metrics for the grid cell using smoothed ride data corresponding to the grid cell;
normalizing the one or more trip metrics for the grid cell; and
computing the defect score using the one or more normalized trip metrics.

11. The method of claim 1, wherein the provided information identifies the selected trip access point as a recommended pick-up location.

12. The method of claim 1, wherein the provided information includes the defect score for the grid cell for display by the client device on an interface including the selected trip access point with an indication of the defect score.

13. The method of claim 1, wherein the defect score is above a defect score threshold, and the provided information includes a notification for display by the client device which includes a warning about the geographic position based on the defect score exceeding the defect score threshold.

14. The method of claim 1, wherein the grid cells of the plurality of grid cells are hexagonal.

15. A non-transitory computer-readable storage medium storing computer-executable instructions that, in response to executing, cause a device comprising a processor to perform operations comprising:
receiving, by a transportation management system from a client device, information associated with requesting a trip, the client device located at a geographic position;
identifying, based on the geographic position, a grid cell of a plurality of grids cells included in a geographic grid representing a spatial index of historical trip data;
determining a defect score for the grid cell indicating a likelihood of defects occurring for trips using trip access points within the grid cell, the defect score determined based on one or more trip metrics corresponding to the historical trip data associated with the grid cell;
selecting, based on the defect score, a trip access point from a set of candidate trip access points for the trip; and
providing information describing the trip to the client device, the provided information including the selected trip access point.

16. The non-transitory computer-readable storage medium of claim 15, wherein the operations further comprise:
responsive to the defect score being below a defect score threshold, requesting, from the client device, user input describing one or more environmental characteristics of the geographic position;
receiving, from the client device, information describing one or more environmental characteristics of the geographic position; and
updating the spatial index of historical ride data based on the received information describing the one or more environmental characteristics.

17. The non-transitory computer-readable storage medium of claim 15, wherein the one or more trip metrics include at least one of a trip cancellation rate corresponding to the grid cell, a trip request rate corresponding to the grid cell, a trip access point distance error corresponding to the grid cell, or a completed trip count for the grid cell.

18. The non-transitory computer-readable storage medium of claim 15, wherein determining the defect score comprises:
training a defect score model to determine defect scores for grid cells using the spatial index of historical trip data; and
determining the defect score by inputting the one or more trip metrics of the grid cell to the defect score model.

19. The non-transitory computer-readable storage medium of claim 15, wherein the operations further comprise:
generating the geographic grid providing the spatial index of the trip data, the generating comprising:
receiving trip data associated with a plurality of trips facilitated by the transportation management system during a time period; and
associating the received trip data with corresponding grid cells of the plurality of grid cells at a plurality of resolutions of the geographic grid.

20. A computing device comprising:
a processor; and
a non-transitory computer-readable storage medium storing computer-executable instructions that, in response to executing, cause the processor to perform operations comprising:
receiving, by a transportation management system from a client device, information associated with requesting a trip, the client device located at a geographic position;
identifying, based on the geographic position, a grid cell of a plurality of grids cells included in a geographic grid representing a spatial index of historical trip data;
determining a defect score for the grid cell indicating a likelihood of defects occurring for trips using trip access points within the grid cell, the defect score determined based on one or more trip metrics corresponding to the historical trip data associated with the grid cell;
selecting, based on the defect score, a trip access point from a set of candidate trip access points for the trip; and
providing information describing the trip to the client device, the provided information including the selected trip access point.
